(19) United States
(12) Patent Application Publication
(10) Pub. No.: US 2008/0230754 A1
(43) Pub. Date: Sep. 25, 2008

(54) INK FOR COLOR FILTER, COLOR FILTER, IMAGE DISPLAY DEVICE AND ELECTRONIC APPARATUS

(75) Inventors: Hiroshi TAKIGUCHI, Suwa (JP); Hiroshi KIGUCHI, Suwa (JP); Masaya SHIBATANI, Matsumoto (JP); Mitsuhiro ISOBE, Kofu (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/050,534

(22) Filed: Mar. 18, 2008

(30) Foreign Application Priority Data
Mar. 19, 2007 (JP) 2007-071652

(51) Int. Cl. G02B 5/23

(52) U.S. Cl. 252/586

(57) ABSTRACT

Ink for a color filter is used for manufacturing a color filter by an ink-jet method and includes a colorant and a liquid medium in which the colorant is dissolved and/or dispersed. The liquid medium includes a compound that has an alkoxyl group and/or acetyl group whose carbon number is 4 or more at an end of a molecular chain, and a swelling ratio of an epoxy-based adhesive is 30% or less after the hardened epoxy-based adhesive is left sealed in the liquid medium for 10 days under atmospheric pressure and at 40° C.

### CROSS REFERENCE TO RELATED APPLICATIONS

This application claims priority to Japanese Patent Application No. 2007-071652 filed Mar. 19, 2007, which is hereby expressly incorporated by reference herein in its entirety.

### BACKGROUND OF THE INVENTION

1. Technical Field

The present invention relates to ink for a color filter, a color filter, an image display device and an electronic apparatus.

2. Related Art

A color filter is generally used in a liquid crystal display (LCD) device or the like which is capable of color display. Conventional color filters are fabricated by using a commonly-known photolithography method. The method includes a step in which a material (a colored layer forming constituent material) containing colorant, photosensitive resin, functional monomer, a polymerization initiator and the like is applied onto a substrate and a film is then formed from the applied material on the substrate, and an exposure or development step in which the film is irradiated with light through a photo-mask. When such a photolithography method is adopted to form a color filter, a film is formed over the entire substrate, and then only a fraction of the film is hardened. As such, almost all the rest of the film is removed. These steps are generally repeated in the manufacturing process in order to prevent one color from mixing with another color in the color filter. According to the method, most of the film formed in the manufacturing process of the color filter is removed and only a part of the film is left as a colored layer of the color filter. This raises manufacturing costs of the color filter and it is also undesirable in terms of resource saving.

Meanwhile, a method for fabricating a colored layer in a color filter by using an ink-jet head (a droplet discharge head) has been recently proposed. JP-A-2002-372613 is an example. According to the method, it becomes easy to control a position to which a droplet of a colored layer forming material (colored layer forming constituent material) is discharged, and it is possible to reduce the amount of the colored layer forming constituent material wasted. Therefore the impact on the environment can be reduced and the manufacturing cost can also be reduced. However when droplets keep being discharged for a long time period, a problem sometimes occurs such that the volume of a droplet at a discharge operation fluctuates. If the volume of a droplet fluctuates, the colorant concentration differs among color parts where it should have identical color density. Consequently, irregularity or unevenness in color density, colorant concentration and the like occurs, or characteristics (particularly chromatic characteristics such as contrast ratio and color reproducibility) differ among color filters, thereby deteriorating the quality of the color filter. An industrial droplet discharge device used for manufacturing a color filter is completely different from the one used as a consumer printer. For example, the industrial-use droplet discharge device is required to discharge a large amount of droplets for a long time period. Moreover, ink used for the droplet discharge device (industrial use) for the fabrication of a color filter is thicker and its density is larger than that of the ink used for the consumer printer. Therefore a larger burden is imposed on a droplet discharge head of the droplet discharge device compared with that of a consumer-use printer. Because the droplet discharge device is used under such sever conditions, the ink-jet head deteriorates quickly. Thus it is necessary to repair the ink-jet head or to replace the ink-jet head to new one relatively often. Further, droplet discharge conditions (for example, voltage waveform) need to be adjusted every time the ink-jet head is repaired or replaced in order to prevent characteristic differences among the manufactured color filters. This reduces the production efficiency of the color filter.

### SUMMARY

An advantage of the present invention is to provide ink for a color filter manufactured by a ink-jet method, the ink being favorably used for the fabrication of the color filter and with which it is possible reduce the unevenness or irregularity in color density or colorant concentration among parts of the color filter and thereby to reliably manufacture the color filter with a fine characteristic uniformity among manufactured pieces. Another advantage of the invention is to provide a color filter in which the unevenness or irregularity in color density or colorant concentration among parts is made small and whose quality is consistent among manufactured pieces, an image display device equipped with such color filter and an electronic apparatus thereof.

According to a first aspect of the invention, ink for a color filter which is used for manufacturing a color filter by an ink-jet method includes a colorant and a liquid medium in which the colorant is dissolved and/or dispersed, the liquid medium including a compound that has an alkoxyl group and/or acetyl group whose carbon number is 4 or more at an end of a molecular chain, and a swelling ratio of an epoxy-based adhesive is 30% or less where the hardened epoxy-based adhesive is left in the sealed liquid medium for 10 days under atmospheric pressure and at 40° C. In this way, it is possible to provide a color filter ink for an ink-jet method that can be favorably used to manufacture a color filter in which the unevenness or irregularity in color or color density among parts can be reduced and which has a fine characteristic uniformity among manufactured pieces.

It is preferable that the liquid medium include a compound having an acetyl group at both ends of a molecular chain. In this way it is possible to effectively prevent the deterioration, clogging and the like of the droplet discharge head (the ink-jet head) which discharges the ink for a color filter. As such it is possible to manufacture high-quality color filters with a fine characteristic uniformity among the manufactured pieces.

It is preferable that the liquid medium include a compound having an alkoxyl group whose carbon number is 4 or more at both ends of a molecular chain. In this way it is possible to effectively prevent the deterioration, clogging and the like of the droplet discharge head (the ink-jet head) which discharges the ink for a color filter. As such it is possible to manufacture high-quality color filters with a fine characteristic uniformity among the manufactured pieces.

It is preferable that the liquid medium includes a compound having an ether oxygen atom that is coupled to a secondary carbon atom in a molecule. In this way it is possible to effectively prevent the deterioration, clogging and the like of the droplet discharge head (the ink-jet head) which discharges the ink for a color filter. As such it is possible to manufacture high-quality color filters with a fine characteristic uniformity among the manufactured pieces.

It is also preferable that the ink be discharged from a liquid droplet head in which a nozzle plate is adhesively bonded with the epoxy-based adhesive for forming a color filter. In this way it is possible to effectively prevent the deterioration, clogging and the like of the droplet discharge head (the ink-jet head) which discharges the ink for a color filter. As such it is possible to manufacture high-quality color filters with a fine characteristic uniformity among the manufactured pieces.

It is preferable that the epoxy-based adhesive contain an epoxy-based resin and an aliphatic polyamine. In this way the unevenness or irregularity in the color or color density among parts can be effectively reduced and it is possible to manufacture the color filter stably with a fine characteristic uniformity among manufactured pieces over a long time period.

It is preferable that a boiling point of the liquid medium at atmospheric pressure be in the range of 180 to 300° C. In this way it is possible to effectively prevent the clogging and the like of the droplet discharge head and therefore the production efficiency of the color filter can be improved.

It is also preferable that a vapor pressure of the liquid medium at 25° C. be 0.1 mmHg or less. In this way it is possible to effectively prevent the clogging and the like of the droplet discharge head and therefore the production efficiency of the color filter can be improved.

A color filter according to a second aspect of the invention is manufactured by using the above-mentioned ink for a color filter. In this way, it is possible to provide a color filter in which the unevenness or irregularity in color or color density among parts can be reduced and which has a fine characteristic uniformity among manufactured pieces.

An image display device according to a third aspect of the invention includes the above-mentioned color filter. In this way, it is possible to provide an image display device in which the unevenness or irregularity in color or color density among parts in a display part can be reduced and which has a fine characteristic uniformity among manufactured pieces.

It is preferable that the image display device be a liquid crystal panel. In this way, it is possible to provide an image display device in which the unevenness or irregularity in color or color density among parts can be reduced and which has a fine characteristic uniformity among manufactured pieces.

An electronic apparatus according to a fourth aspect of the invention includes the above-mentioned image display device. In this way, it is possible to provide an electronic apparatus in which the unevenness or irregularity in color or color density among parts is a display part can be reduced and which has a fine characteristic uniformity among manufactured pieces.

### BRIEF DESCRIPTION OF THE DRAWINGS

The invention will be described with reference to the accompanying drawings, wherein like numbers reference like elements.

FIG. 1 is a sectional view of a color filter according to an embodiment of the invention.

FIG. 2 is a sectional view showing a method for manufacturing the color filter.

FIG. 3 is a perspective view of a droplet discharge device used for the manufacturing of the color filter.

FIG. 4 is a view of a droplet discharger of the droplet discharge device shown in FIG. 3 when observed from a stage side.

FIG. 5 is a bottom view of a droplet discharge head of the droplet discharge device shown in FIG. 3.

FIG. 6A is a sectional perspective view and FIG. 6B is a sectional view of the droplet discharge head of the droplet discharge device shown in FIG. 3.

FIG. 7 is a sectional view of a liquid crystal display device according to an embodiment.

FIG. 8 is a perspective view of a mobile (or notebook type) personal computer which is one example of an electronic apparatus according to the embodiment of the invention showing its configuration.

FIG. 9 is a perspective view of a mobile phone (including a personal handy phone system or PHS) which is another example of the electronic apparatus according to the embodiment showing its configuration.

FIG. 10 is a perspective view of a digital still camera which is another example of the electronic apparatus according to the embodiment showing its configuration.

### DESCRIPTION OF EXEMPLARY EMBODIMENTS

Embodiments of the invention will be described.

### Ink for Color Filter

Ink for a color filter according to an embodiment of the invention is used for the fabrication of a color filter (fabrication of a color part in a color filter), particularly for the manufacturing of a color filter by using an ink-jet method. The ink for a color filter contains a colorant, a liquid medium in which the colorant is dissolved and/or dispersed, a resin material and the like.

Colorant

A color filter usually has color parts that are respectively colored with different colors (typically three colors corresponding to red (R), green (G) and blue (B)). The colorants used for the color parts are appropriately selected depending on the color tones of the color parts. Various pigments and dyes can be used as the colorant of the ink for a color filter.

As for pigment, for example, C.I. Pigment Red 2, 3, 5, 17, 22, 23, 38, 81, 48:1, 48:2, 48:3, 48:4, 49:1, 52:1, 53:1, 57:1, 63:1, 112, 122, 144, 146, 149, 166, 170, 176, 177, 178, 179, 185, 202, 207, 209, 254, 101, 102, 105, 106, 108, 108:1; C.I. Pigment Green 7, 36, 15, 17, 18, 19, 26, 50; C.I. Pigment Blue 1, 15, 15:1, 15:2, 15:3, 15:4, 15:6, 17:1, 18, 60, 27, 28, 29, 35, 36, 80; C.I. Pigment Yellow 1, 3, 12, 13, 14, 17, 55, 73, 74, 81, 83, 93, 94, 95, 97, 108, 109, 110, 129, 138, 139, 150, 151, 153, 154, 168, 184, 185, 34, 35, 35:1, 37, 37:1, 42, 43, 53, 157; C.I. Pigment Violet 1, 3, 19, 23, 50, 14, 16; C.I. Pigment Orange 5, 13, 16, 36, 43, 20, 20:1, 104; C.I. Pigment Brown 25, 7, 11, 33 or the like can be used.

As for dye, for example, azo dyes, anthraquinone dyes, condensed polycyclic aromatic carbonyl dyes, indigoid dyes, carbonium dyes, phthalocyanine dyes, methine and polymethine dyes, or the like can be used. Specific examples of the dye includes C.I. Direct Red 2, 4, 9, 23, 26, 28, 31, 39, 62, 63, 72, 75, 76, 79, 80, 81, 83, 84, 89, 92, 95, 111, 173, 184, 207, 211, 212, 214, 218, 221, 223, 224, 225, 226, 227, 232, 233, 240, 241, 242, 243, 247; C.I. Acid Red 35, 42, 51, 52, 57, 62, 80, 82, 111, 114, 118, 119, 127, 128, 131, 143, 145, 151, 154, 157, 158, 211, 249, 254, 257, 261, 263, 266, 289, 299, 301, 305, 319, 336, 337, 361, 396, 397; C.I. Reactive Red 3, 13, 17, 19, 21, 22, 23, 24, 29, 35, 37, 40, 41, 43, 45, 49, 55; C.I. Basic Red 12, 13, 14, 15, 18, 22, 23, 24, 25, 27, 29, 35, 36, 38, 39, 45, 46; C.I. Direct Violet 7, 9, 47, 48, 51, 66, 90, 93, 94, 95, 98, 100, 101; C.I. Acid Violet 5, 9, 11, 34, 43, 47, 48, 51, 75, 90, 103, 126; C.I. Reactive Violet 1, 3, 4, 5, 6, 7, 8, 9, 16, 17, 22, 23, 24, 26, 27, 33, 34; C.I. Basic Violet 1, 2, 3, 7, 10, 15, 16, 20, 21, 25, 27, 28, 35, 37, 39, 40, 48; C.I. Direct Yellow 8, 9, 11, 12, 27, 28, 29, 33, 35, 39, 41, 44, 50, 53, 58, 59, 68, 87, 93, 95, 96, 98,100, 106, 108, 109, 110, 130, 142, 144, 161, 163; C.I. Acid Yellow 17, 19, 23, 25, 39, 40, 42, 44, 49, 50, 61, 64, 76, 79, 110, 127, 1 35, 143, 151, 159, 169, 174,. 190, 195, 196, 197, 199, 218, 219, 222, 227; C.I. Reactive Yellow 2, 3, 13, 14, 15, 17, 18, 23, 24, 25, 26, 27, 29, 35, 37, 41, 42; C.I. Basic Yellow 1, 2, 4, 11, 13, 14, 15, 19, 21, 23, 24, 25, 28, 29, 32, 36, 39, 40; C.I. Acid Green 16; C.I. Acid Blue 9,45,80,83,90,185; C.I. Basic Orange 21, 23 and the like.

As the colorant, powder of the above-mentioned material and whose surfaces are treated so as to for example impart a lyophilic quality (a treatment to improve affinity for a hereinafter described liquid medium) can be used. In this way, it is possible to improve for example dispersibility or dispersion stability of the colorant particles. The surface treatment of the colorant includes for example modification of the surface property of the colorant particle with polymer. As the polymer for modifying the surface of the colorant, polymers disclosed in JP-A 8-259876, commercially available polymers or oligomers for dispersing a pigment or the like can be used. Moreover, the colorant can be used as more than one kind combined from the above listed materials.

According to the embodiment, the colorant in the ink for a color filter can either be dissolved or dispersed in the hereunder described liquid medium. In the case where the colorant is dispersed in the liquid medium, it is preferable that an average particle size of the colorant is in the range of 20-200 nm, and more preferably 30-180 nm. By having this particle size, it is possible to develop excellent light resistance, bright coloration and the like of the color filter fabricated from the ink as well as to obtain the dispersion stability of the colorant of the ink.

A content rate of the colorant in the ink for a color filter is preferably set in the rage of 2-20 wt %, and more preferably 3-15 wt %. By setting the content rate of the colorant at the above mention range, discharge characteristics of a droplet discharge head (ink-jet head) used for the fabrication of the color filter can be made excellent and the durability of the fabricated color filter can also be made excellent. In addition, it is possible to secure a sufficient color density of the fabricated color filter.

Liquid Medium

The liquid medium has a function of dissolving and/or dispersing the above-described colorant. In other words, the liquid medium serves as a solvent and/or dispersion medium. Most of the liquid medium is generally removed in the fabrication process of the color filter.

According to the embodiment of the ink for a color filter, the liquid medium is formed of a material having an alkoxyl group and/or acetyl group whose carbon number is 4 or more at an end of the molecular chain, and the material should cause a swelling ratio of the hardened material of an epoxy-based adhesive (hereunder referred as to “swelling ratio of the epoxy-based adhesive”) to be 30% or less after the hardened epoxy-based adhesive is left sealed in the liquid medium for 10 days under atmospheric pressure and at 40° C. By using a liquid medium which satisfies this condition, it is possible to stabilize conditions including the droplet discharge amount and the like in the ink-jet manufacturing process of the color filter even if the droplet discharge is performed for a long time period. Consequently it is possible to manufacture color filters with a constant quality for a long time period. In other words, the unevenness or irregularity in color density or colorant concentration among parts can be reduced and it is possible to stably manufacture the color filter with a fine characteristic uniformity among manufactured pieces for a long time. Moreover, by satisfying the above-mentioned condition, it is possible to effectively prevent the deterioration of a droplet discharge head used for the droplet discharge. Accordingly the frequency of maintenance such as the replacement, repair and the like of the droplet discharge head can be reduced and thereby the production efficiency of the color filter can be improved.

If the swelling ratio of the epoxy-based adhesive in the liquid medium is too large, the droplet discharge conditions become unstable in the manufacturing of the color filter by using the ink-jet method when the droplet discharge is performed for a long time period. Thus it is difficult to sufficiently control the unevenness or irregularity in the color density or colorant concentration among parts of the manufactured color filter. Moreover in the case where a large number of color filters are manufactured, different characteristics become large among the manufactured pieces and thus it is difficult to stably fabricate color filters with a fine quality. The swelling ratio can be measured by using for example a disk-shaped test specimen whose size is 6 mm in diameter and 4 mm in thickness.

It is preferable that the epoxy-based adhesive contain an epoxy-based resin and an aliphatic polyamine. Where such epoxy-based adhesive is used to firmly fix the head body with a nozzle plate in a hereinafter-described droplet discharge head, the adhesive can effectively prevent the droplet discharge head from adversely vibrating at the time of droplet discharging. The hardened epoxy-based adhesive can be easily affected by typically used ink for a color filter and it was difficult to maintain a stable discharge condition over a long time period where the epoxy-based adhesive was applied in the droplet discharge head. In contrast, the liquid medium according to the embodiment of the invention less affects the epoxy-based adhesive so that it is possible to favorably stabilize conditions including the droplet discharge amount and the like for a long time period. As a result, the unevenness or irregularity in the color density or colorant concentration among parts can be effectively reduced and it is possible to manufacture the color filter stably with a fine characteristic uniformity among manufactured pieces over a long time period.

According to the above-described embodiment, the swelling ratio of the hardened epoxy-based adhesive is 30% or less after the hardened epoxy-based adhesive is left sealed in the liquid medium for 10 days under atmospheric pressure and at 40° C. However it is preferable that the swelling ratio of the hardened epoxy-based adhesive under the above-mentioned condition be 25% or less, and more preferably 20% or less. By setting the swelling ratio at such a percentage, the above-mentioned advantageous effects according to the embodiment of the invention will become more prominent.

When the liquid medium does not have the above-mentioned chemical structure, adverse affects towards the droplet discharge head cannot be sufficiently prevented and it becomes difficult to obtain an appropriate viscosity of the ink for a color filter, an appropriate vapor pressure (volatilization resistivity) and the like. Consequently the droplet discharge conditions become unstable in the manufacturing of the color filter by using the ink-jet method when the droplet discharge is performed for a long time period. Thus it is difficult to sufficiently control the unevenness or irregularity in the color density or colorant concentration among parts of the manufactured color filter. Moreover in the case where a large number of color filters are manufactured, different characteristics become large among the manufactured pieces and thereby it is difficult to stably fabricate color filters with a fine quality.

A chemical compound which has the above-mentioned chemical structure and can be used as the liquid medium encompasses for example 2-(2-methoxy-1-methylethoxy)-1-methylethylacetate), diethyleneglycol monoethyl ether-acetate, bis(2-butoxyethyl) ether, ethylene glycol di-n-butylate, 1,3-butylenegolycol diacetate, diethyleneglycol monobutyl ether-acetate, 1,6-diacetoxyhexane, butoxyethanol, 3-methoxybutylacetate, ethyleneglycol monobutyl ehteracetate, cyclohexyl acetate, ethylene glycol diacetate, propylene glycol diacetate, 1-butoxy-2-propanol, 3-methoxy-n-butylacetate, ethylene glycol monohexyl ether, dipropylene glycol n-butylether, diethylene glycol butyl methyl ether, triethylene glycol butyl methyl ether, tripropylene glycol n-butylether, dipropylene glycol n-butyl methyl ether, 1-butoxy-2-propanol and 2-butoxy-1-propanol. One of the above-mentioned materials alone or more than two of them combined can be used.

According to the embodiment of the ink for a color filter, the liquid medium contains a material preferably having an alkoxyl group and/or acetyl group whose carbon number is 4 or more at the end of the molecular chain. Alternatively the material of the liquid medium may have an acetyl group at both ends of its molecular chain. By adopting such a liquid medium, it is possible to effectively prevent the deterioration, clogging and the like of the droplet discharge head (the ink-jet head) which discharges the ink for a color filter. As such it is possible to manufacture high-quality color filters with a fine characteristic uniformity among the manufactured pieces. A specific example of the chemical compound (liquid medium) having an acetyl group at both ends of the molecular chain includes 1,3-butylene glycol diacetate, 1,6-diacetoxyhexane, ethylene glycol diacetate, propylene glycol diacetate and the like.

Moreover, the material of the liquid medium may be a compound having an alkoxyl group whose carbon number is 4 or more at both ends of the molecular chain. By adopting such a liquid medium, it is possible to effectively prevent the deterioration, clogging and the like of the droplet discharge head (the ink-jet head) which discharges the ink for a color filter. As such it is possible to manufacture high-quality color filters with a fine characteristic uniformity among the manufactured pieces. A specific example of the chemical compound (liquid medium) having an alkoxyl group at both ends of the molecular chain includes bis (2-butoxyethyl) ether, triethylene glycol dibutyl ether and the like.

Moreover, the material of the liquid medium may be a compound having an ether oxygen atom that is coupled to a secondary carbon atom (two carbon atoms bonded each other) in the molecule. By adopting such a liquid medium, it is possible to effectively prevent the deterioration, clogging and the like of the droplet discharge head (the ink-jet head) which discharges the ink for a color filter. As such it is possible to manufacture high-quality color filters with a fine characteristic uniformity among the manufactured pieces. A specific example of the chemical compound (liquid medium) having an ether oxygen atom that is coupled to a secondary carbon atom in the molecule includes 2-(2-methoxy-1-methylethoxy)-1-methylethylacetate, 3-methoxybutylacetate, dipropylene glycol n-butyl methyl ether, tripropylene glycol n-butylether, dipropylene glycol n-butyl methyl ether, 1-butoxy-2-propanol and 2-butoxy-1-propanol and the like.

A boiling point of the liquid medium at atmospheric pressure (1 atm.) is preferably in the range of 180-300° C., more preferably 190-290° C., and most preferably 230-280° C. When the boiling point of the liquid medium at atmospheric pressure is set in the above range, the deterioration, clogging and the like of the droplet discharge head which discharges the ink for a color filter can be effectively prevented and thereby it is possible to improve the production efficiency of the color filter.

Moreover, a vapor pressure of the liquid medium at 25° C. is preferably 0.1 mmHg or less, and more preferably 0.05 mmHg or less. When the vapor pressure of the liquid medium is set in such range, the deterioration, clogging and the like of the droplet discharge head which discharges the ink for a color filter can be effectively prevented and thereby it is possible to improve the production efficiency of the color filter.

Moreover, a content ratio of the liquid medium in the ink for a color filter is preferably in the range of 70-98 wt %, and more preferably 80-95 wt %. By setting the content rate of the liquid medium in such range, discharge characteristics of a droplet discharge head used for the fabrication of the color filter can be made excellent and the durability of the fabricated color filter can also be made excellent. In addition, it is possible to secure a sufficient color density of the fabricated color filter.

Dispersant

The ink for a color filter can contain a dispersant. By adding a dispersant, it is possible to make the dispersion state of a pigment stable even if the ink for a color filter contains pigment having a low dispersibility. Consequently an ink for a color filter that has a fine stability in conservation can be obtained.

The dispersant includes for example, cationic, anionic, nonionic and amphoteric surfactants, a silicone-based surfactant, a fluorine-based surfactant and the like.

Specific examples of the surfactant encompasses polyoxyethylene alkyl ethers such as polyoxyethylene lauryl ether, polyoxyethylene stearyl ether and polyoxyethylene oleyl ether; polyoxyethylene alkylphenyl ethers such as polyoxyethylene n-octylphenyl ether and polyoxyethylene n-nonylphenyl ether; polyethylene glycol diesters such as polyethylene glycol dilaurate and polyethylene glycol distearate; sorbitan fatty acid esters; fatty acid modified polyesters; tertiary amine modified polyurethanes; and polyethyleneimines. In addition, the followings are available on the market under the trade names of KP (Shin-Etsu Chemical Co., Ltd.), Polyflow (Kyoeisha Chemical Co., Ltd.). F-Top (Tohkem Products Corporation), Megafac (Dainippon Ink and Chemicals, Inc.), Florade (Sumitomo 3M Limited), Asahi Guard and Surflon (Asaki Glass Co., Ltd.), Disperbyk (BYK-Chemie GmbH) and Solsperse 3000, 5000, 11200, 12000, 13240, 13650, 13940, 16000, 17000, 18000, 20000, 21000, 22000, 24000SC and 24000GR (Zeneca Ltd.) and the like.

In addition, for example, a chemical compound having a cyamelide can also be used as the dispersant. When such chemical compound is used as the dispersant, the dispersibility of the pigment in the ink for a color filter can be made excellent thus a fine discharge stability of the ink can be obtained.

Moreover, chemical compounds having the following structure represented by Formula (I) or Formula (II) can also be adopted as the dispersant. When such chemical compound is used as the dispersant, the dispersibility of the colorant (pigment) in the ink for a color filter can be made great and thus an excellent discharge stability of the ink can be obtained.

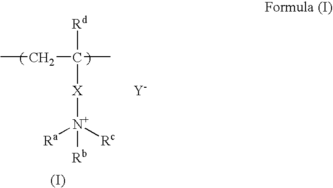

wherein R^{a}, R^{b} and R^{c} can be respectively a hydrogen atom, or a cyclic hydrogen carbon group or chain that can be replaced. Alternatively, more than one of R^{a}, R^{b} and R^{c} can be bonded each other and form a cyclic structure. R^{d} denotes a hydrogen atom or a methyl group, X indicates a divalent linking group and Y⁻ designates a counter anion.

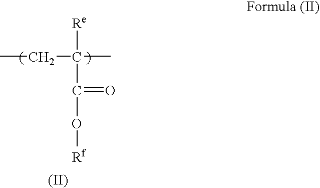

wherein R^{e} denotes an hydrogen atom or a methyl group, and R^{f} is a cyclic alkyl or an alkyl chain that may have a substituent, or an aryl group or an aralkyl group that may have a substituent.

A content ratio of the dispersant in the ink for a color filter is preferably in the range of 0.5-15 wt %, and more preferably 0.5-8 wt %.

Resin Material

The ink for a color filter typically contains a resin material (a binder resin). By adding a resin material, it is possible to impart a fine adhesion between the colored layer and the substrate in the manufactured color filter. Thereby it is possible to make the durability of the color filter excellent. Any resins including various thermoplastic resins and various thermosetting resins can be adopted as the resin material that is contained in the ink for a color filter. Particularly an epoxy-based resin is preferable because it has a high transparency, it is very hard and its heat shrinkage is small. Therefore it is possible to obtain a fine adhesion of the color part to the substrate. As the resin material contained in the ink for a color filter, an epoxy-based resin having a silylacetate structure (SiOCOCH₃) and an epoxy structure is particularly preferable among the epoxy-based resins. With such resin, the droplet discharge by the ink-jet method can be appropriately performed and a fine adhesion between the colored layer and the substrate can be obtained. Consequently the durability of the fabricated color filter can be made excellent.

A content ratio of the resin material in the ink for a color filter is preferably in the range of 0.5-10 wt %, and more preferably 1-5 wt %. By setting the content ratio of the resin material in this range, discharge characteristics of a droplet discharge head which is used for the fabrication of the color filter can be made excellent and the durability of the fabricated color filter can also be made excellent. In addition, it is possible to secure a sufficient color density of the fabricated color filter. If the content ratio of the resin material is too low, the discharge characteristics of the ink for a color filter can deteriorate and the hardness of the manufactured color part can decrease, which decreases the durability of the manufactured color filter. On the other hand, if the content ratio of the resin material is too high, it becomes difficult to secure a sufficient color density of the fabricated color filter.

Other Constituent

The ink for a color filter according to the embodiment may contain other component if needed. Such other component (additive) includes, for example, various cross-linkers; various polymerization initiators; dispersion aids such as a blue pigment derivative exemplified by a copper phthalocyanine derivative or yellow pigment derivative; filler such as glass or alumina; polymer compound such as a polyvinyl alcohol, polyethylene glycol monoalkyl ether or polyfluoroalkyl acrylate; adhesion promoting agent such as vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane or 3-mercaptopropyltrimethoxysilane; antioxidant such as 2,2-thiobis(4-methyl-6-t-butylphenol) or 2,6-di-t-butylphenol; ultraviolet light absorber such as 2-(3-t-butyl-5-methyl-2-hydroxyphenyl)-5-chlorobenzotriazole or alkoxybenzophenone; coagulation preventing agent such as sodium polyacrylate; ink jet discharge stabilizing agent such as methanol, ethanol, i-propanol, n-butanol and glycerin; and surfactant available on the market under the trade name of F Top EF301, EF303 or EF352 (of Shin Akita Kasei Co., Ltd.), Megafac F171, F172, F173 or F178K (of Dainippon Ink and Chemicals, Inc.), Florade FC430 or FC431 (of Sumitomo 3M Limited), Asahi Guard AG710 or Surflon S-382, SC-101, SC-102, SC-103, SC-104, SC-105 or SC-106 (of Asahi Glass Co., Ltd.), KP341 (Shin-Etsu Chemical Co., Ltd.), and Polyflow No. 75 or No. 95 (Kyoeisha Chemical Co., Ltd.).

Moreover the ink for a color filter according to the embodiment can contain a thermal acid generating agent, an acid cross-linking agent or the like. The thermal acid generating agent is a component which generates an acid by heat, as exemplified by onium salts such as sulfonium salts, benzothiazolium salts, ammonium salts and phosphonium salts. Among these, sulfonium salts and benzothiazolium salts are particularly preferred.

A viscosity of the ink for a color filter at 25° C. (the viscosity measured by a vibratory viscometer) is not particularly limited however 5-15 mPa·s is preferable and more preferably 5-10 mPa·s. By setting the viscosity of the ink for a color filter in such range, variation in a droplet volume of the ink discharged by the ink-jet method can be made very small and clogging and the like at the droplet discharge head can be reliably prevented. The measurement of the viscosity can be performed with for example a vibratory viscometer in conformity with Japanese Industrial Standards (JIS) Z8809.

### Ink Set

The above-described ink for a color filter is used for the fabrication of a color filter by the ink-jet method. Color filters generally include color parts colored with more than one color (usually three colors Red, Green and Blue corresponding to three primary colors of light). To form the color parts that are colored with more than one color, color filter inks of different colors corresponding to each color of the color parts are provided. More specifically, an ink set having inks of more than one color for a color filter is used in the manufacturing of the color filter. According to an embodiment of the invention, in the manufacturing process, the ink for a color filter is used to form at least one type of the color part in the color filter. However it is preferable that the ink be used for the formation of the entire color parts of all the colors.

### Color Filter

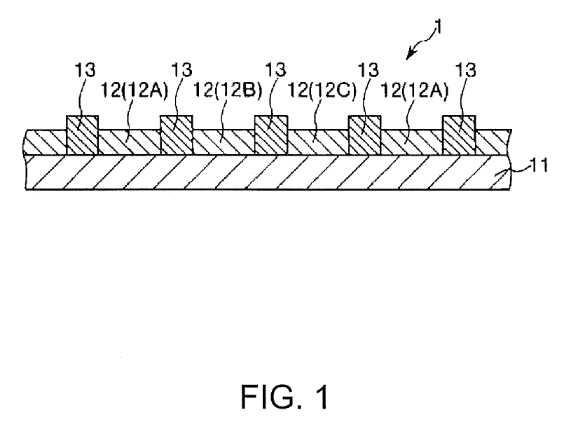

An example of the color filter manufactured by using the above-described ink for a color filter (ink set) is now described. FIG. 1 is a sectional view of a color filter according to an embodiment of the invention. Referring to FIG. 1, a color filter 1 includes a substrate 11, and a color part 12 which is formed by using the above-described ink for a color filter. The color part 12 includes a first color part 12A, a second color part 12B and a third color part 12C that are respectively colored with a different color. A partition wall 13 is provided between the two adjacent color parts 12.

Substrate

The substrate 11 is a light-transmissive plate and provided so as to hold the color part 12 and the partition wall 13. The substrate 11 is preferably made of a substantially transparent material since a clear image can be formed with light beams transmitted through the color filter 1. Moreover the substrate 11 preferably has a fine heat resistance and mechanical strength because deformation and the like which is caused by heat applied in a manufacturing process of the color filter 1 can be for example prevented. As the material for the substrate 11 which satisfies such conditions, there are for example glass, silicon, polycarbonate, polyester, aromatic polyamide, polyamideimide, polyimide, norbornene series ring-opening polymer and hydrogenated norbornene series ring-opening polyme, and the like.

Color Part

The color part 12 is the one fabricated by using the above-described ink for a color filter. Because the color part 12 is formed by using the above-described ink for a color filter, the characteristic difference among pixels is small. Therefore the chance of the unevenness or irregularity in color density or colorant concentration occurring in the color filter 1 is made small and the color filter 1 is highly reliable.

Each color part 12 is disposed within a cell 14 which is an area surrounded by the hereunder described partition walls 13. The first color part 12A, the second color part 12B and the third color part 12C are respectively colored with a different color. For example, the first color part 12A can be made a red filter region (R), the second color part 12B can be made a green filter region (G) and the third color part 12C can be a blue filter region (B). A set of color parts 12A, 12B and 12C forms a single pixel. A predetermined number of color parts 12 are arranged vertically and horizontally in the color filter 1. In the case of a color filter for a High-Vision display, 1366×768 pixels are arranged. In the case of a color filter for a Full High-Vision display, 1920×1080 pixels are disposed in the color filter. In the case of a color filter for a Super High-Vision display, 7680×4320 pixels are provided. The color filter 1 can have extra pixels other than the pixels in a display region.

Partition Wall

The partition wall (bank) 13 is formed between each two adjacent color parts 12. Thereby it can securely prevent the colors of adjacent color parts 12 from mixing with each other. Consequently it is possible to display a clear image reliably. The partition wall 13 can be made of a transparent material though it is preferable that it be made of a light shielding material. By adopting the light shielding material, an image can be displayed with a fine contrast. A color of the partition wall (bank) 13 is not particularly limited however black is preferable because the contrast of a displayed image can be made excellent.

A height of the partition wall 13 is not particularly limited however it is preferably larger than a film thickness of the color part 12 since this can surely prevent the colors of the adjacent color parts 12 from mixing. A thickness of the partition wall 13 is preferably set in the range of 0.1-10 μm, and more preferably 0.5-3.5 μm. In this way it is possible to prevent the colors of the adjacent color parts 12 from being mixed and to make a viewing angle excellent in an image display device and an electronic apparatus that are equipped with the color filter 1.

Any material can be used to form the partition wall 13. For example, a material mainly including resin is preferably adopted. With such a material, the partition wall 13 can be easily formed into a desired shape in a way described later. Where the partition wall 13 also serves as a light-shielding part, the partition wall can be formed of a light-absorbing material such as carbon black.

### Manufacturing Method for Color Filter

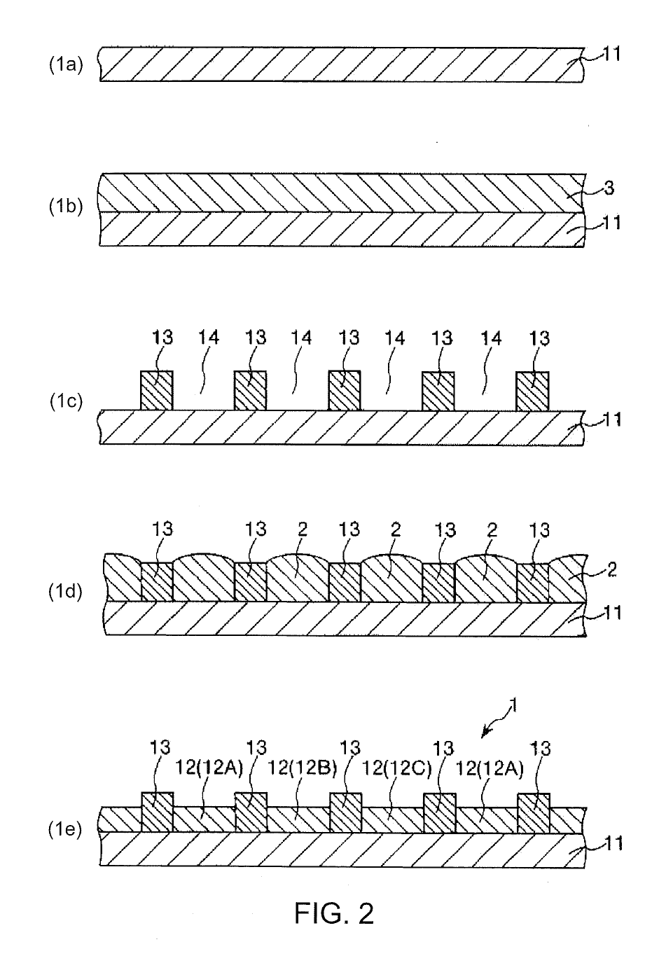

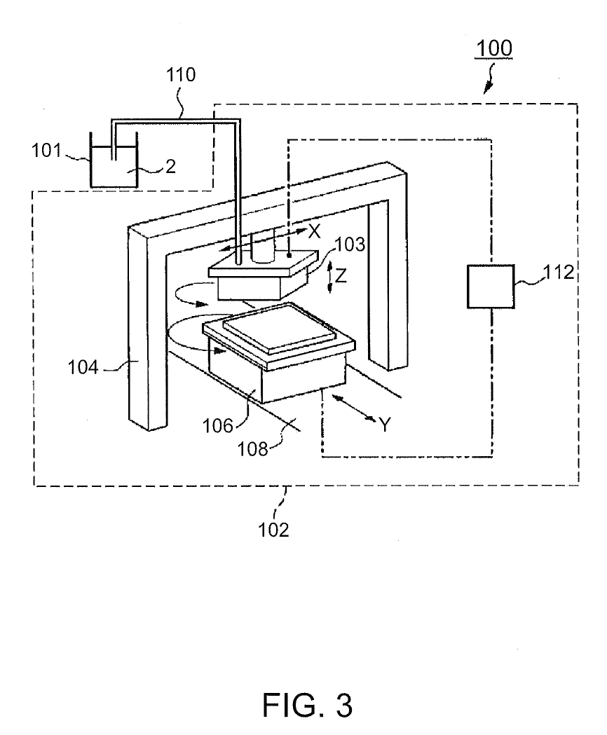

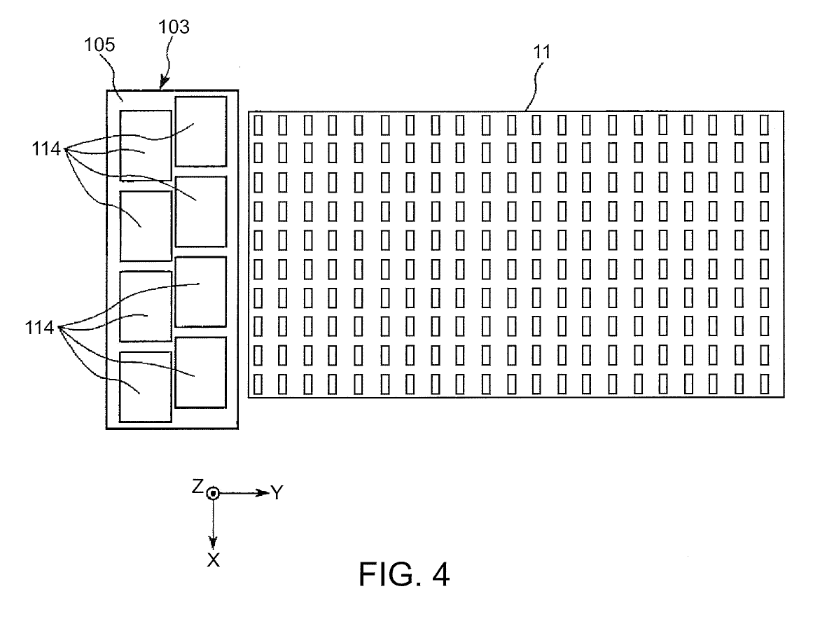

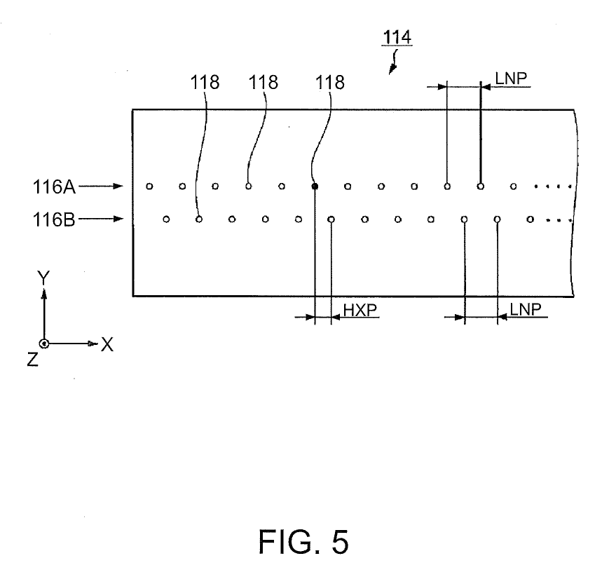

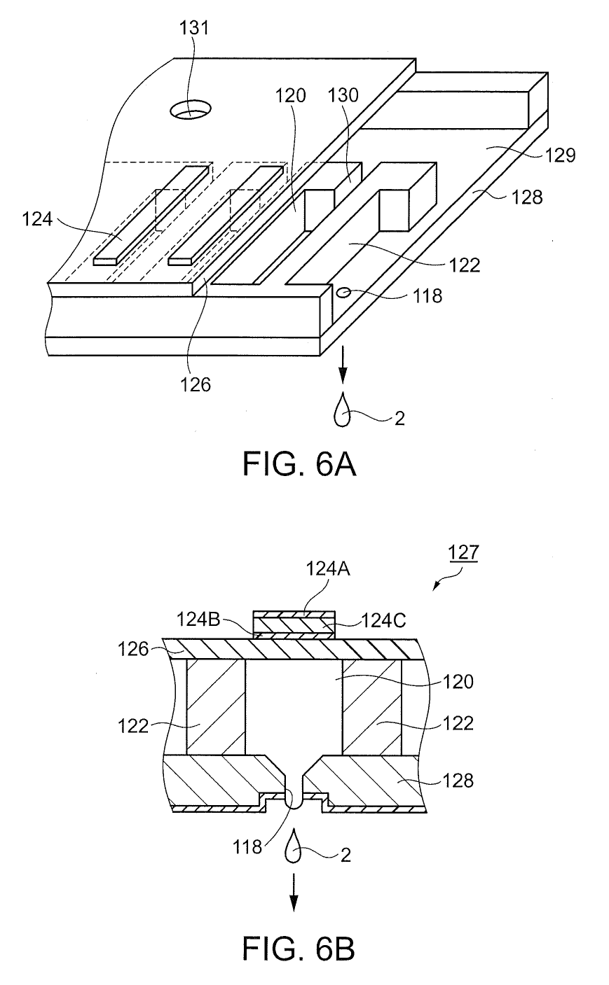

An example of a method for manufacturing the color filter 1 is now described. FIG. 2 is a sectional view showing the method for manufacturing the color filter, FIG. 3 is a perspective view of a droplet discharge device used for the manufacturing of the color filter, FIG. 4 is a view of a droplet discharger of the droplet discharge device when observed from a stage side, FIG. 5 is a bottom view of a droplet discharge head of the droplet discharge device shown in FIG. 3, FIG. 6A is a sectional perspective view and FIG. 6B is a sectional view of the droplet discharge head of the droplet discharge device shown in FIG. 3.

Referring to FIG. 2, the method for manufacturing a color filter according to an embodiment includes a substrate preparation step (1a), a partition wall formation step (1b, 1c) in which the partition wall 13 is formed on the substrate 11, an ink application step (1d) in which an ink 2 for a color filter is imparted onto an area surrounded by the partition wall 13 by an ink-jet method, and a color part formation step (1e) in which the color part 12 is hardened by removing the liquid medium from the ink 2 for a color filter.

Substrate Preparation Step

The substrate 11 is prepared (1a). It is preferable that a cleaning process of the substrate 11 prepared in this step be performed. Furthermore, a pretreatment such as a chemical treatment by using for example a silane coupling agent, a plasma treatment, ion plating, spattering, a gas-phase reaction and a vacuum deposition can be performed for the substrate 11.

Partition Wall Formation Step

An application film 3 is then formed by blanket-depositing a radiation sensitive material for the partition wall of the substrate 11 onto one side of the substrate (1b). After the radiation sensitive material is deposited on the substrate 11, a pre-bake process can be performed if necessary. The pre-bake can be for example performed under the following conditions: a heating temperature of 50-150° C. and a heating duration of 30-600 seconds.

A post exposure bake (PEB) process is then carried out by irradiating the substrate through a photo-mask. A developing process using an alkaline developer is subsequently performed and the partition wall 13 is formed (1c). The PEB can be carried out with for example a heating temperature of 50-150° C., a heating duration of 30-600 seconds and a radiation irradiation intensity of 1-500 mJ/cm². The developing process can be performed by a solution placing method, a dipping method, a vibratory immersing method or the like. A developing time is for example 10-300 seconds. After the developing process, a post-bake process can be performed if necessary. The post-bake can be for example performed under the following conditions: a heating temperature of 150-280° C. and a heating duration of 3-120 minutes.

Ink Application Step

The ink 2 for a color filter is provided in the cell 14 which is surrounded by the partition wall 13 by an ink-jet method (14d). In this step, the ink 2 includes more than one type of ink 2 corresponding to the colors of the color parts 12 which are to be colored with more than one color. Since the partition wall 13 is provided, it is possible to prevent the inks 2 for color filters from being mixed each other.

Discharge of the ink 2 for a color filter is performed by using the droplet discharge device shown in FIGS. 3-6. Referring to FIG. 3, a droplet discharging device 100 used in this step includes a tank 101 where the ink 2 for a color filter is stored, tube 110, and a discharging and scanning part 102 into which the ink 2 is supplied from the tank 101 through the tube 110. The discharging and scanning part 102 includes a droplet discharger 103 and a first positioning control device 104 (transportation device) that controls a position of the droplet discharger 103. The droplet discharger 103 has plural droplet discharge heads 114 (ink-jet head) mounted on a carriage 105. The discharging and scanning part 102 further includes a stage 106 that holds the substrate 11 on which the partition wall 13 has been formed in the previous step (hereunder simply referred as to the “substrate 11”), a second positioning control device 108 (transportation device) that controls a position of the stage 106 and a controller 112. The tank 101 is coupled with the droplet discharge heads 114 in the droplet discharger 103 through the tube 110. The ink 2 for a color filter is provided to each of the droplet discharge heads 114 from the tank 101 by utilizing compressed air.

The first positioning control device 104 moves the droplet discharger 103 along an X-axis direction and a Z-axis direction that is orthogonal to the X-axis direction according to a signal from the controller 112. Moreover the first positioning control device 104 can rotate the droplet discharger 103 around an axis which is parallel with the Z axis. In this embodiment, the Z-axis direction is the direction parallel to the vertical direction (or the direction of gravitational force). The second positioning control device 108 moves the stage 106 along a Y-axis direction that is orthogonal to both of the X-axis direction and the Z-axis direction according to a signal from the controller 112. Moreover the second positioning control device 108 can rotates the stage 106 around an axis parallel to the Z axis. The stage 106 has a plane that is parallel to both the X-axis direction and the Y-axis direction. The stage 106 can fix and hold the substrate 11 that has the cell 14 where the ink 2 for a color filter should be provided on the plane. As described above, the droplet discharger 103 is moved in the X-axis direction and the Z-axis direction by the first positioning control device 104. On the other hand, the stage 106 is moved in the Y-axis direction by the second positioning control device 108. Thereby a relative position of the droplet discharge head 114 with respect to the position of the stage 106 is changed (the substrate 11 held by the stage 106 moves relatively to the droplet discharger 103) by the first positioning control device 104 and the second positioning control device 108. The controller 112 receives a discharge data which indicates the position where the ink 2 for a color filter is to be discharged from an external information processing device.

Referring to FIG. 4, the droplet discharger 103 has a plurality of droplet discharge heads 114, each of which has substantially the same structure, and the carriage 105 that holds the droplet discharge heads 114. In this embodiment, the number of the droplet discharge heads 114 held by the droplet discharger 103 is eight. Each of the droplet discharge heads 114 has a bottom face on which a plurality of hereinafter described nozzles 118. The bottom face of each droplet discharge head 114 has a shape of a polygon having two long sides and two short sides. The bottom face of the discharge head 114 which is held by the droplet discharger 103 faces toward the stage 106 side. The long side and the short side of the droplet discharge head 114 are parallel to the X-axis direction and the Y-axis direction, respectively.

Referring to FIG. 5, the droplet discharge head 114 includes the plurality of nozzles 118 that are arranged in the X-axis direction. The plurality of nozzles 118 are arranged with a nozzle pitch HXP in the X-axis direction in the droplet discharge head 114. The nozzle pitch HXP is not particularly limited. For example it can be 50-90 μm. The “nozzle pitch HXP in the X-axis direction in the droplet discharge head 114” corresponds to the pitch between the projected nozzle images obtained by projecting all of the nozzles 118 in the droplet discharge head 114 onto the X axis along the Y-axis direction.

In this embodiment, the plurality of nozzles 118 in the droplet discharge head 114 is arranged in a first nozzle line 116A and a second nozzle line 116B both of which extends in the X-axis direction. The first and second nozzle lines 116A and 116B are arranged parallel to each other with a predetermined distance therebetween. Each of the first and second nozzle lines 116A, 116B includes ninety nozzles 118 each of which is disposed with a predetermined pitch LNP and lines up in the X-axis direction. The nozzle pitch LNP is not particularly limited. For example it can be 100-180 μm.

The position of the second nozzle line 116B is shifted in the positive direction of the X-axis (to the right in FIG. 5) by the half of the length of the nozzle pitch LNP with respect to the first nozzle line 116A. Therefore, the nozzle pitch HXP in the X-axis direction in the droplet discharge head 114 is half of the nozzle pitch LNP of the first nozzle line 116A (or the second nozzle line 116B). This means that a linear density of the nozzles in the X-axis direction in the droplet discharge head 114 is twice as that of the first nozzle line 116A (or the second nozzle line 116B). In this specification, the term “linear density of the nozzles in the X-axis direction” refers to the number of the projected nozzle images per unit length, the projected nozzle images being obtained by projecting the plurality of nozzles onto the X axis along the Y-axis. The number of the nozzle line which the droplet discharge head 114 includes is not obviously limited to two. The droplet discharge head 114 may include “M” nozzle lines, where “M” represents an integer of 1 or more. In this case, the plurality of nozzles 118 in each of the “M” nozzle lines is arranged at a pitch which is “M” times of the nozzle pitch HXP. When “M” is an integer of 2 or more, with respect to one of the “M” nozzle lines, the nozzle positions of the other (M-1) nozzle lines are respectively shifted along the X-axis direction by a distance which is “i” times of the nozzle pitch HXP without any overlaps, where “i” represents an integer of 1 to (M-1).

In this embodiment, the first and second nozzle lines 116A, 116B respectively include 90 nozzles. In other words 180 nozzles are provided in the single droplet discharge head 114. However 5 nozzles in each end of the first nozzle line 116A are set as “non-operating nozzles”. In the same manner, 5 nozzles at each end of the second nozzle line 116B are set as the “non-operating nozzles”. The ink 2 for a color filter is not discharged from these 20 non-operating nozzles. Thus the ink 2 is discharged from the 160 nozzles 118 among the 180 nozzles 118 in the droplet discharge head 114.

Referring to FIG. 4, a plurality of the above-described droplet discharge heads 114 is arranged in two lines along the X-axis direction in the droplet discharger 103. The droplet discharge head 114 in one line is arranged such that a part of it overlaps with the droplet discharge head 114 in the other line when it is viewed from the Y-axis direction. Therefore, in the droplet discharger 103, the nozzles 118 that discharge the ink 2 for a color filter are sequentially arranged in the X-axis direction at the above-mentioned nozzle pitch HXP and so as to extend through the length of the substrate 11 in the X-axis direction. In the droplet discharger 103 according to the embodiment, the droplet discharge heads 114 are arranged so as to cover the dimension of the substrate 11 in the X-axis direction. Alternatively the droplet discharge heads 114 can be arranged so as to cover only a part of the length of the substrate 11 in the X-axis direction.

Referring to FIG. 6A and FIG. 6B, the droplet discharge head 114 is an inkjet head. More specifically, each of the droplet discharge heads 114 includes a diaphragm 126 and a nozzle plate 128. A liquid reservoir 129 is provided between the diaphragm 126 and the nozzle plate 128, the liquid reservoir 129 being always supplied with the color filter ink 2 which is fed from the tank 101 through an opening 131.

A partition wall 122 which is provided in the plural number is disposed between the diaphragm 126 and the nozzle plate 128. A space surrounded by the diaphragm 126, the nozzle plate 128, and a pair of the partition walls 122 is a cavity 120. Since the cavities 120 are provided corresponding to the nozzles 118, the number of cavities 120 is equal to the number of nozzles 118. The ink 2 for a color filter is supplied from the liquid reservoirs 129 to the cavity 120 through a feeding aperture 130 which is situated between a pair of partition walls 122.

A vibrating element 124 is disposed on the diaphragm 126 corresponding to the cavity 120. The vibrating element 124 includes a piezo element 124C and a pair of electrodes 124A, 124B which sandwiches the piezo element 124C. A driving voltage is applied between the pair of electrodes 124A, 124B and the ink 2 for a color filter is discharged from the corresponding nozzle 118. The nozzle 118 is formed so as to have a shape with which the ink 2 is appropriately discharged in the Z-axis direction through the nozzle 118.

Meanwhile, an adhesive is usually used for joints of the components in the droplet discharge head. For example, an adhesive is used for the joint between the partition wall and the nozzle plate, which significantly affects the durability of the droplet discharge head. Droplets of ink for a color filter are repeatedly discharged, the ink for a color filter is continuously supplied into the droplet discharge head (the cavity), and the vibration energy and the like which is generated by the droplet discharge is applied to the joint where the adhesive is applied. A droplet discharge device (industrial use) used for the manufacturing of a color filter is completely different from the one used as a printer (consumer use). For example the industrial-use droplet discharge device is required to discharge a large number of droplets for a long time period. Moreover, ink used for the droplet discharge device (industrial use) for the fabrication of a color filter is thicker and its density is larger than that of the ink used for the printer (consumer use). Therefore a larger burden is imposed on a droplet discharge head of the droplet discharge device compared with that of a consumer-use printer. Because the droplet discharge device is used under such sever conditions, the adhesive is sometimes swollen because of the ink for a color filter and the adhesion by the adhesive can be insufficient. This causes problems such that the amount of the droplet discharged is destabilized. Moreover, a cleaning operation such as vacuum up process is periodically conducted for manufacturing devices. If the adhesion strength of the nozzle plate is declined at this point, the plate cannot bear the pressure change caused by the vacuum up and structural defects such as distortion and deflection may occur. If it happens to a part of the nozzles, a structural difference is generated among the nozzle so that the discharge of the droplets becomes unstable. When such problem takes place, unevenness in color density among the color parts where they should have identical color density. As a result, irregularity or unevenness in color, color density and the like occurs and characteristics (particularly chromatic characteristics such as contrast ratio and color reproducibility) differ among color filters, deteriorating the reliability of the color filter. In contrast, the present embodiment adopts the ink for a color filter which satisfies the above-mentioned conditions so that such problems can be effectively prevented even when the droplet discharge is repeatedly performed over a long time period.

The droplet discharge head 114 according to the embodiment is not particularly limited, however it is preferable that the nozzle plate 128 is adhered with an epoxy-based adhesive which has a fine resistance to chemicals. In this way, the deterioration, clogging and the like of the droplet discharge head which discharges the ink for a color filter can be effectively prevented and it is possible to manufacture high-quality color filters with a fine characteristic uniformity among the manufactured pieces.

The epoxy-based adhesive used in the droplet discharge head 114 preferably contains an epoxy-based resin and an aliphatic polyamine. Where such epoxy-based adhesive is used in the droplet discharge head, the adhesive can effectively prevent that the droplet discharge head from adversely vibrating at the time of droplet discharging. However a hardened epoxy-based adhesive can be easily affected by typically used ink for a color filter. For this reason, it was difficult to maintain a stable discharge condition over a long time period where the epoxy-based adhesive was applied in the droplet discharge head. In contrast, the present embodiment adopts the above color filter ink that affects the epoxy-based adhesive less so that it is possible to favorably stabilize conditions including the droplet discharge amount and the like for a long time period. As a result, the unevenness or irregularity in the color, color density and the like among parts can be effectively reduced and it is possible to manufacture the color filter stably with a fine characteristic uniformity among manufactured pieces over a long time period.

The epoxy-based adhesive used in the droplet discharge head 114 can be procured on the market under the registered trade name of for example AE-40 (manufactured by Ajinomoto-Fine-Techno Co., Inc.), 931-1 (manufactured by Ablestick Corp.), LOCETITE 3609 (manufactured by Henkel Japan Corp.), Scotchweld EW2010 (manufactured by 3M Corp.) and the like.

The controller 112 (see FIG. 3) can be made capable of sending a signal to each of the plurality of vibrating elements 124 independently. That is, the volumes of the ink 2 for a color filter which is discharged through each nozzle 118 can be controlled depending on the signal sent from the controller 112. Moreover, the controller 112 can set a discharging nozzle 118 and a non-discharging nozzle 118 during the application scanning operation.

In this specification, a portion including the nozzle 118, the cavity 120 corresponding to the nozzle 118, and the vibrating element 124 corresponding to the cavity 120 is sometimes referred to as “discharging portion 127”. According to this, the single droplet discharge head 114 has the same number of the discharging portions 127 as nozzles 118.

By using the above-described droplet discharge device 100, the inks 2 whose colors correspond to the colors of the color parts 12 are provided in the cell 14. With the device, it is possible to apply the inks 2 for a color filter into the cell 14 efficiently and selectively. Though the droplet discharge device 100 shown in the drawing has the tank 101 storing the ink 2, the tube 110 and the like only for a single color, as any of these components can be provided as the number of colors in the colored parts of the color filter 1. Alternatively the number of the droplet discharge devices 100 corresponding to the number of the colors of the inks 2 for a color filter can be used for the manufacturing of the color filter 1. Moreover, the droplet discharge head 114 can adopt an electrostatic actuator instead of the piezo element as the driving element. Furthermore, the droplet discharge head 114 can also adopt an electrothermal transducer as the driving element. In this case, the ink for a color filter is discharged by utilizing the thermal expansion of a material caused by the electrothermal transducer.

Color Part Formation Step

The liquid medium is removed from the ink 2 for a color filter which is provided in the cell 14, and the solid color part 12 is obtained (1e). Through the above-described steps, the color filter 1 is obtained. In this step, the resin material and the cross-linking component can react with each other if desired. The removal of the liquid medium can be performed by for example heating. At this point, the substrate 11 on which the ink 2 for a color filter is disposed can be placed under a reduced pressure. In this way it is possible to prevent adverse effects on the substrate 11 and the like as well as to promote the removal of the liquid medium efficiently. Moreover, irradiation can be conducted in this step. By the irradiation, it is possible to promote the reaction between the resin material and the cross-linking component and the like.

### Image Display Device

A liquid crystal display device according to an embodiment, which is an example of the image display device (electrooptical device) having the color filter 1, is now described.

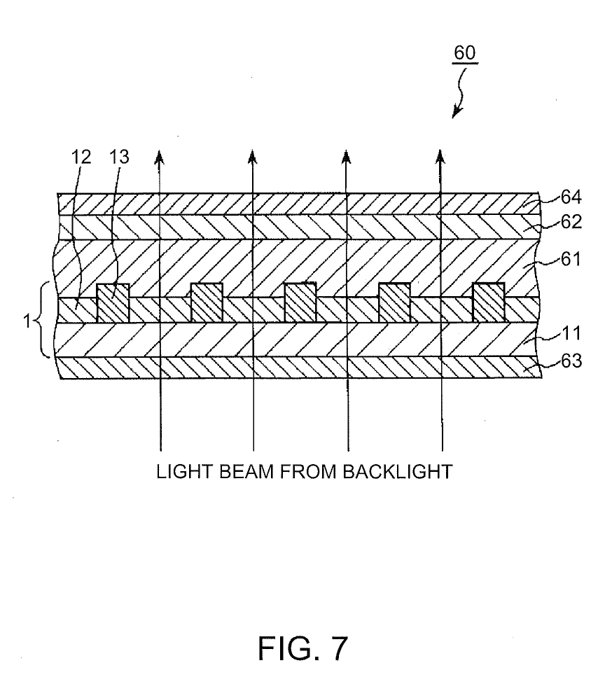

FIG. 7 is a sectional view of a liquid crystal display device according to an embodiment. Referring to FIG. 7, a liquid crystal display device 60 includes the color filter 1, a substrate 62 (opposing substrate) which is disposed so as to oppose the color parts 12 of the color filter 1, a liquid crystal layer 61 which is made of liquid crystal enclosed in the space between the color filter 1 and the substrate 62, a polarizing plate 63 which is disposed on the under side of the substrate 11 of the color filter 1 in FIG. 7, and another polarizing plate 64 which is disposed on the upper side of the substrate 62 in FIG. 7. The substrate 62 is a light-transmissive substrate at optical wavelengths, and made from for example a glass substrate.

The liquid crystal display device 60 further includes a plurality of pixel electrodes that are light-transmissive at optical wavelengths and arranged in matrix, a plurality of switching elements (for example, thin film transistors: TFTs) that corresponds to the pixel electrodes, and a common electrode that is also light-transmissive at optical wavelengths (these components are not shown in the drawing). In the liquid crystal display device 60, a light beam emitted from an unshown back-light enters from the color filter 1 side (from the bottom side in FIG. 7). Light beams which entered into the color parts 12 (12A, 12B, 12C) come out as the colored light beams correspondingly colored with the colors of the color parts 12 (12A, 12B, 12C) from the other side. The color parts 12 are formed from the ink 2 for a color filter according to the embodiment of the invention so that a difference in a characteristic among the pixels is made very small. Consequently, the liquid crystal display device 60 can stably display an image in which the unevenness or irregularity in the color, color density and the like among parts are reduced.

### Electronic Apparatus

An image display device 1000 (electrooptical device) including the above-described liquid crystal display device that has the color filter 1 can be applied as a display part of various electronic apparatuses.

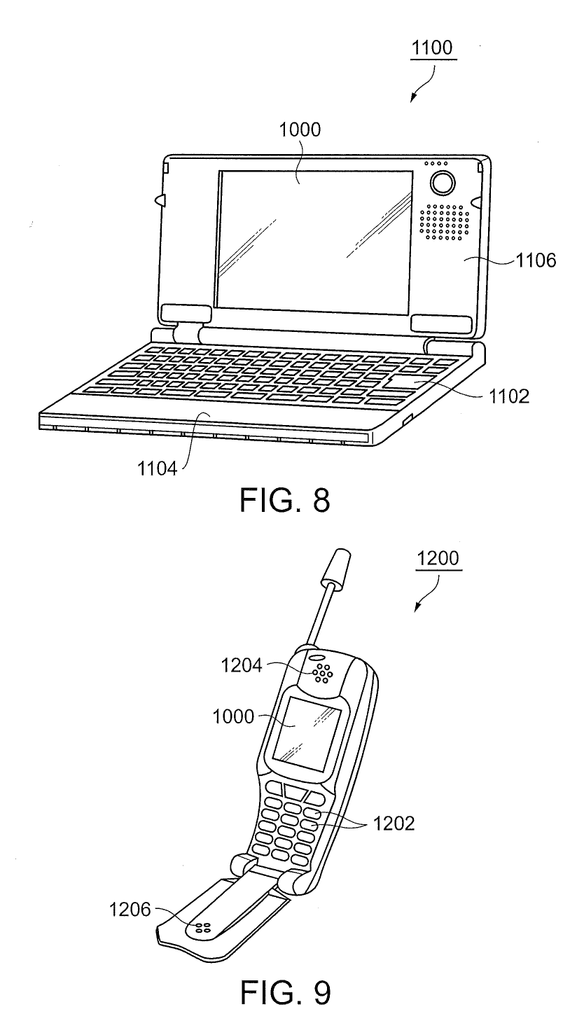

FIG. 8 is a perspective view of a mobile (or notebook type) personal computer which is one example of the electronic apparatus according to the embodiment of the invention showing its configuration.

Referring to FIG. 8, a personal computer 1100 includes a main body 1104 equipped with a keyboard 1102, and a display unit 1106. The display unit 1106 is held by the main body 1104 such that it is rotatable with respect to the main body through a hinge structure. In the personal computer 1100, the display unit 1106 has the image display device 1000.

FIG. 9 is a perspective view of a mobile phone (including a personal handy phone system or PHS) which is another example of the electronic apparatus according to the embodiment showing its configuration. Referring to FIG. 9, a mobile phone set 1200 includes a plurality of operation buttons 1202, an ear piece 1204, a mouth piece 1206 and a display part which is the display image device 1000.

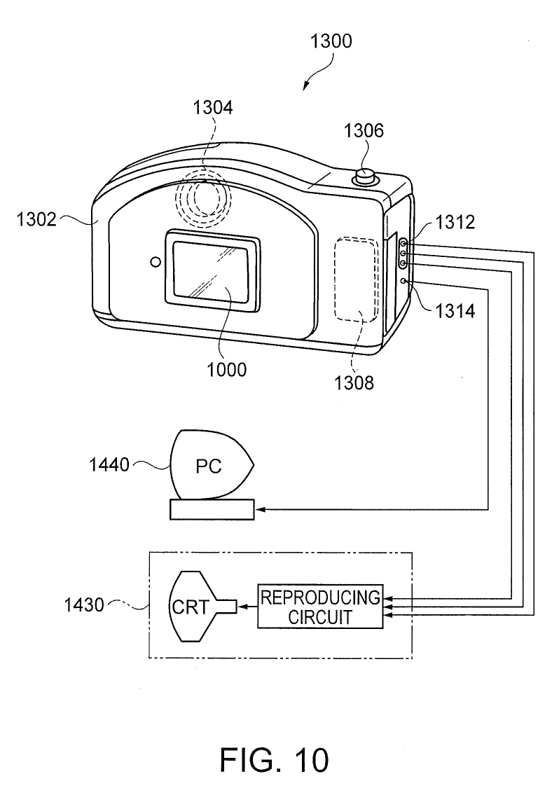

FIG. 10 is a perspective view of a digital still camera which is another example of the electronic apparatus according to the embodiment showing its configuration. In the drawing, the connections with external devices are also schematically illustrated.

In contrast to an ordinary camera in which a silver salt photographic film is photosensitized by an optical image of an object, a digital still camera 1300 generates an image signal (picture signal) by photo-electrically converting an optical image of the object through an imaging element such as a CCD (charge coupled device).

The display image device 1000 is provided on a back side of a case (body) 1302 of the digital still camera 1300 as a display part which displays an image based on a signal imaged by the CCD. The display part displays the object as an electronic image and serves as a finder. A circuit substrate 1308 is disposed in the case. A memory that can store (register) the image signal is mounded on the circuit substrate 1308.

A light receiving unit 1304 which includes an optical lens (imaging optics), the CCD and the like is provided on the front side (back side in the drawing) of the case 1302. When a photographer confirms the object image displayed on the display part, and presses a shutter button 1306, the image signal of the CCD at that moment is transferred to the memory on the circuit substrate 1308 and is then stored therein.

In the digital still camera 1300, a video signal output terminal 1312 and an input/output terminal 1314 for data communication are provided on a side face of the case 1302. As illustrated in the drawing, the video signal output terminal 1312 is coupled to a television monitor 1430, and the input/output terminal 1314 for data communication is coupled to a personal computer 1440 according to needs. Moreover, the system can be configured such that image signals stored in the memory 1308 are outputted to the television monitor 1430 or the personal computer 1440 by a predetermined operation.

In addition to the above described personal computer (mobile personal computer), the mobile phone and the digital still camera, the electronic apparatus according to the embodiment can be also applied to televisions (for exampled a liquid crystal TV), view-finder type or direct-view type video tape recorders, laptop personal computers, car navigation devices, pagers, electronic notebooks (including one with communication function), electronic dictionaries, desktop calculators, electronic game consoles, word processors, work stations, video telephones, crime prevention video monitors, electronic binoculars, POS terminals, medical equipment (for example, electronic clinical thermometer, blood pressure gauge, blood sugar meter, electrocardiogram measurement instrument, ultrasonic diagnostic equipment and electronic endoscope), fish finders, various kinds of measurement equipment, instruments (for example, instruments for train, aircraft and ship), flight simulators, various monitors, projection-type display devices such as a projector and the like. Particularly, as the display size of televisions has been increasing recently, if a color filter which is fabricated by using the hitherto known color filter ink is applied to an electronic apparatus having a large display part (for example the display whose diagonal size is 80 cm or larger), problems such as the unevenness or irregularity in color and color density of the color filter often occur. Whereas the invention is applied, such problems can be assuredly prevented. Therefore the advantageous effects of the invention can be effectively seen when it is applied to such large display part.

The invention is not limited to the above-described embodiments. Various modifications and variations are possible within the spirit and scope of the invention. For example, though the inks for a color filter corresponding to the colors of the color parts were applied in the cell and the liquid medium was removed from the inks in the cell all at once, in other words, though the color part formation step was performed only once in the above-described embodiment, the ink application step and the color parts formation step can be repeatedly performed corresponding to the number of the colors used.

Moreover, in the color filter according to the embodiment of the invention, a protection film covering the color part can be further provided on the side of the color part which is opposite to the substrate side. In this way, the damage or deterioration of the color part can be effectively prevented.

The invention also encompasses the structures that serve the equivalent function and exert the equivalent effect as those of the embodiments of the color filter, image display device and electronic apparatus. The invention also encompasses the structure in which a hitherto know art is added to the structure described in the above embodiments.

### EXAMPLES

[1] Preparation of Ink for a Color Filter

### Example 1

As the resin material, a resin “a” was synthesized in the following way. In a four-neck flask, 320 w/t parts of n-hexane, 86 w/t parts of methacrylic acid and 111 w/t parts of triethylamine were placed then a thermometer, a reflux condenser, a stirring machine and a nitrogen gas feed port were attached to the four-neck flask. While cooling the four-neck flask with ice water 120 w/t parts of trimethylchlorsilane was dripped into the flask. At this point, the temperature of the reaction system was set to 25° C. or lower. The reaction was continued for a hour at 25° C. Subsequently hydrochloride of the triethylamin was separated by filtration and the n-hexane was removed from the obtained filtrate under a reduced pressure. The solution was then distilled under reduced pressure and refined, and an ethylene unsaturated monomer having the silylacetate structure was obtained.

As a solvent, 100 w/t parts of bis (2-butoxyethyl) ether was placed in a four-neck flask to which a thermometer, a reflux condenser, a stirring machine and a nitrogen gas feed port were attached. The bis (2-butoxyethyl) ether in the flask was stirred and heated to 60° C. Subsequently, a mixture of 27 w/t parts of the above-mentioned ethylene unsaturated monomer, 30 w/t parts of glycidyl methacrylate, 36 w/t parts of styrene and 8 w/t parts of 2,2′-azobis-(2,4-dimethyl valeronitrile) was dripped into the flask for an hour. After the dropping, the flask was left at 60° C. for 2 hours and then 0.08 w/t parts of 2,2′-azobis-(2,4-dimethyl valeronitrile) was further added and reacted at 60° C. for 6 hours. Unreacted monomers were removed by a decompression treatment and then the solution of the resin “a”, which is the epoxy-based resin having a silylacetate structure and an epoxy structure was obtained.

While bis (2-butoxyethyl) ether (the liquid medium) was prepared. Disperbyk-161 (manufactured by BYK Japan KK: a chemical compound having a cyamelide) which is a dispersion liquid, and C.I. pigment red 254 and C.I. pigment yellow 150 which are colorants are added to the prepared liquid medium. The mixture was introduced into a bead mill (that used zirconia bead whose size was 0.65 mm) and the pigments were ground and a pigment dispersed liquid was obtained.

Thereafter, the solution of the resin “a” and the pigment dispersed liquid was mixed. In this way, an ink (R ink) for a red color filter was prepared. The average particle sizes of the C. I. pigment red 254 and the C.I. pigment yellow 150 in the R ink were both 140 nm.

In the same manner as the above-described ink for a red color filter except that types of the colorant and the amounts of components used were changed, an ink (G ink) for a green color filter and an ink (B ink) for a blue color filter were prepared. In this way, an ink set of three color inks of R, G, B was obtained. The average particle sizes of the C. I. pigment green 36 and the C.I. pigment yellow 150 in the G ink, and the C.I. pigment blue 15:6 in the B ink were all 150 nm.

### Examples 2 through 13

In the same manner as the first example, inks (ink set) for a color filter were prepared. Types of the liquid medium and the amount use of each component are given in the tables below. Where the composition of the liquid medium was changed, the resin “a” was synthesized by using a solvent whose composition was changed according to the change of the liquid medium and a solution of such resin “a” was used to prepare the ink for a color filter.

### Comparative Examples 1 through 8

In the same manner as the first example, inks (ink set) for a color filter were prepared. Types of the liquid medium and the amount use of each component are given in the tables below. Where the composition of the liquid medium was changed, the resin “a” was synthesized by using a solvent whose composition was changed according to the change of the liquid medium and a solution of such resin “a” was used to prepare the ink for a color filter.

The composition and viscosity of each ink for a color filter, and properties of a used liquid medium in the examples and the comparative examples are given in the following Table 1, Table 2 and Table 3. In the tables, C.I. pigment red 254 is denoted as “PR254”, C.I. pigment green 36 is written as “PG36”, C.I. pigment blue 15:6 is “PB15:6”, C.I. pigment yellow 150 is “PY150”, the above-described resin “a” is denoted as “a”, Disperbyk-161 (the dispersion liquid) is denoted as “b”, bis (2-butoxyethyl) ether is denoted as “A”, 2-(2-methoxy-1-methylethoxy)-1-methylethylacetate is designated as “B”, 3-etoxy ethyl propionate is denoted as “C”, diethyleneglycol monobutyl ehteracetate is detnoted as “D”, 1,3-butylene glycol diacetate is symbolized as “E”, ethylene glycol diacetate is represented as “F”, 4-methyl-1,3-dioxolan-2-on is denoted as “G”, ethyleneglycol monobutyl ehteracetate is “H”, glutaric acid is “I”, tetraethyleneglycol dimethylehter is “J”, and triethyleneglycol dimethylehte is denoted as “K”. The column of “viscosity” in the tables shows the viscosity of each corresponding ink at 25° C. measured by a vibratory viscometer in conformity with Japanese Industrial Standards (JIS) Z8809. The column of “boiling point” in the tables gives the boiling point of the corresponding liquid medium at atmospheric pressure (1 atm.) In the column of “swelling ratio of hardened epoxy-based adhesive”, the swelling ratio of a hardened epoxy-based adhesive which was measured after leaving the hardened epoxy-based adhesive (AE-40 manufactured by Ajinomoto-Fine-Techno Co., Inc., which contains an epoxy based resin and an aliphatic polyamine, in the form of disk-shaped test specimen whose size is 6 mm in diameter and 4 mm in thickness) in a hermetically-sealed liquid medium for 10 days under atmospheric pressure and at 40° C. is given.

TABLE 1

| | | | | | | | | | | | | | PROPERTY OF LIQUID | | |
|---|---|---|---|---|---|---|---|---|---|---|---|---|---|---|---|
| | | INK FOR COLOR FILTER | | | | | | | | | | | MEDIUM | | |
| | | Composition | | | | | | | | | | | | | Swelling |
| | | | | | | Resin | | Dispersion | | Liquid | | | | | Ratio of |
| | | Colorant | | | | Material | | Liquid | | Medium | | | | | hardened |
| | | | Content | | Content | | Content | | Content | | Content | | | | epoxy- |
| | Color | | Ratio | | Ratio | | Ratio | | Ratio | | Ratio | Vis- | Boiling | Vapor | based |
| | of | | [wt. | | [wt. | | [wt. | | [wt. | | [wt. | cosity | Point | Pressure | adhesive |
| | Ink | | pts.] | | pts.] | | pts.] | | pts.] | | pts.] | [mP · s] | [° C.] | [mmHg] | [%] |
| Ex. | R | PR254 | 5.3 | PY150 | 2.0 | a | 1.9 | b | 4.8 | A | 86.0 | 7.2 | 256.0 | 0.01 | 7.83 |
| 1 | G | PG36 | 7.2 | PY150 | 2.9 | a | 2.0 | b | 4.8 | A | 83.1 | 7.0 | 256.0 | 0.01 | 7.83 |
| | B | PB15:6 | 4.9 | — | — | a | 1.9 | b | 4.5 | A | 88.7 | 6.8 | 256.0 | 0.01 | 7.83 |
| Ex. | R | PR254 | 5.2 | PY150 | 1.9 | a | 2.0 | b | 4.9 | A/B | 43.0/43.0 | 5.1 | 234.5 | 0.01 | 14.69 |
| 2 | G | PG36 | 7.0 | PY150 | 2.8 | a | 2.2 | b | 4.8 | A/B | 41.6/41.6 | 5.0 | 234.5 | 0.01 | 14.69 |
| | B | PB15:6 | 4.9 | — | — | a | 1.8 | b | 4.5 | A/B | 44.5/44.5 | 5.0 | 234.5 | 0.01 | 14.69 |
| Ex. | R | PR254 | 5.1 | PY150 | 1.9 | a | 2.0 | b | 4.8 | A/D | 69.0/17.2 | 6.3 | 254.2 | 0.02 | 12.06 |
| 3 | G | PG36 | 7.0 | PY150 | 2.8 | a | 2.1 | b | 4.7 | A/D | 66.7/16.7 | 6.5 | 254.2 | 0.02 | 12.06 |
| | B | PB15:6 | 4.8 | — | — | a | 1.7 | b | 4.5 | A/D | 71.2/17.8 | 6.2 | 254.2 | 0.02 | 12.06 |
| Ex. | R | PR254 | 5.2 | PY150 | 2.1 | a | 2.2 | b | 4.5 | A/E | 68.8/17.2 | 6.4 | 251.2 | 0.02 | 12.17 |
| 4 | G | PG36 | 7.2 | PY150 | 2.9 | a | 2.1 | b | 5.0 | A/E | 66.2/16.6 | 6.5 | 251.2 | 0.02 | 12.17 |
| | B | PB15:6 | 4.9 | — | — | a | 1.9 | b | 4.8 | A/E | 70.7/17.7 | 6.3 | 251.2 | 0.02 | 12.17 |
| Ex. | R | PR254 | 5.0 | PY150 | 1.9 | a | 2.2 | b | 4.8 | A/H | 60.3/25.8 | 6.8 | 236.7 | 0.08 | 14.37 |
| 5 | G | PG36 | 7.3 | PY150 | 3.1 | a | 2.1 | b | 4.9 | A/H | 57.8/24.8 | 6.9 | 236.7 | 0.08 | 14.37 |
| | B | PB15:6 | 4.8 | — | — | a | 1.9 | b | 5.1 | A/H | 61.7/26.5 | 6.5 | 236.7 | 0.08 | 14.37 |
| Ex. | R | PR254 | 5.1 | PY150 | 1.9 | a | 2.9 | b | 5.4 | B | 84.7 | 6.1 | 213.0 | 0.02 | 21.15 |
| 6 | G | PG36 | 7.3 | PY150 | 2.0 | a | 2.8 | b | 5.0 | B | 82.9 | 5.9 | 213.0 | 0.02 | 21.15 |
| | B | PB15:6 | 4.9 | — | — | a | 1.8 | b | 4.9 | B | 88.4 | 5.6 | 213.0 | 0.02 | 21.15 |
| Ex. | R | PR254 | 5.2 | PY150 | 2.2 | a | 2.2 | b | 4.8 | B/D | 59.9/25.7 | 7.3 | 223.1 | 0.03 | 23.51 |
| 7 | G | PG36 | 7.2 | PY150 | 2.0 | a | 1.9 | b | 5.1 | B/D | 58.7/25.1 | 7.1 | 223.1 | 0.03 | 23.51 |
| | B | PB15:6 | 4.9 | — | — | a | 2.3 | b | 5.8 | B/D | 60.9/26.1 | 6.7 | 223.1 | 0.03 | 23.51 |
| Ex. | R | PR254 | 5.3 | PY150 | 2.0 | a | 2.5 | b | 5.0 | B/E | 59.6/25.6 | 6.9 | 218.7 | 0.03 | 23.66 |
| 8 | G | PG36 | 7.2 | PY150 | 3.1 | a | 1.8 | b | 5.1 | B/E | 53.8/29.0 | 6.9 | 219.7 | 0.03 | 24.08 |
| | B | PB15:6 | 4.7 | — | — | a | 1.9 | b | 5.0 | B/E | 44.2/44.2 | 6.9 | 222.5 | 0.03 | 25.33 |

TABLE 2

| | | | | | | | | | | | | | PROPERTY OF LIQUID | | |
|---|---|---|---|---|---|---|---|---|---|---|---|---|---|---|---|
| | | INK FOR COLOR FILTER | | | | | | | | | | | MEDIUM | | |
| | | Composition | | | | | | | | | | | | | Swelling |
| | | | | | | Resin | | Dispersion | | Liquid | | | | | Ratio of |
| | | Colorant | | | | Material | | Liquid | | Medium | | | | | hardened |
| | | | Content | | Content | | Content | | Content | | Content | | | | epoxy- |
| | Color | | Ratio | | Ratio | | Ratio | | Ratio | | Ratio | Vis- | Boiling | Vapor | based |
| | of | | [wt. | | [wt. | | [wt. | | [wt. | | [wt. | cosity | Point | Pressure | adhesive |
| | Ink | | pts.] | | pts.] | | pts.] | | pts.] | | pts.] | [mP · s] | [° C.] | [mmHg] | [%] |
| Ex. | R | PR254 | 5.2 | PY150 | 2.0 | a | 2.1 | b | 4.8 | D | 85.9 | 8.1 | 248.6 | 0.04 | 29.8 |
| 9 | G | PG36 | 7.1 | PY150 | 2.9 | a | 2.2 | b | 4.8 | D | 83.0 | 8.2 | 248.6 | 0.04 | 29.8 |
| | B | PB15:6 | 4.8 | — | — | a | 1.9 | b | 4.5 | D | 88.8 | 7.7 | 248.6 | 0.04 | 29.8 |
| Ex. | R | PR254 | 5.1 | PY150 | 1.9 | a | 2.2 | b | 4.8 | D/E | 43.0/43.0 | 7.9 | 239.4 | 0.04 | 29.26 |
| 10 | G | PG36 | 7.0 | PY150 | 2.9 | a | 2.5 | b | 5.2 | D/E | 41.2/41.2 | 7.9 | 239.4 | 0.04 | 29.26 |
| | B | PB15:6 | 4.9 | — | — | a | 2.1 | b | 4.8 | D/E | 44.1/44.1 | 7.7 | 239.4 | 0.04 | 29.26 |
| Ex. | R | PR254 | 5..1 | PY150 | 1.9 | a | 2.2 | b | 5.1 | E | 86.0 | 7.9 | 232.0 | 0.04 | 29.51 |
| 11 | G | PG36 | 7.0 | PY150 | 2.8 | a | 2.5 | b | 5.2 | E | 82.9 | 8.0 | 232.0 | 0.04 | 29.51 |
| | B | PB15:6 | 4.7 | — | — | a | 2.1 | b | 4.8 | E | 88.7 | 7.6 | 232.0 | 0.04 | 29.51 |
| Ex. | R | PR254 | 5.2 | PY150 | 2.1 | a | 2.2 | b | 4.8 | F | 85.7 | 9.8 | 187.0 | 0.04 | 25.27 |
| 12 | G | PG36 | 7.4 | PY150 | 2.9 | a | 2.5 | b | 5.2 | F | 82.0 | 9.6 | 187.0 | 0.04 | 25.27 |
| | B | PB15:6 | 4.9 | — | — | a | 2.1 | b | 4.6 | F | 88.4 | 9.2 | 187.0 | 0.04 | 25.27 |
| Ex. | R | PR254 | 5.0 | PY150 | 1.9 | a | 2.1 | b | 4.7 | E/H | 69.0/17.3 | 7.6 | 232.9 | 0.08 | 29.53 |
| 13 | G | PG36 | 7.0 | PY150 | 2.7 | a | 2.2 | b | 5.1 | E/H | 66.4/16.6 | 7.5 | 232.9 | 0.08 | 29.53 |
| | B | PB15:6 | 4.7 | — | — | a | 1.8 | b | 4.9 | E/H | 70.9/17.7 | 7.3 | 232.9 | 0.08 | 29.53 |

TABLE 3

| | | | | | | | | | | | | | PROPERTY OF LIQUID | | |
|---|---|---|---|---|---|---|---|---|---|---|---|---|---|---|---|
| | | INK FOR COLOR FILTER | | | | | | | | | | | MEDIUM | | |
| | | Composition | | | | | | | | | | | | | Swelling |
| | | | | | | Resin | | Dispersion | | Liquid | | | | | Ratio of |
| | | Colorant | | | | Material | | Liquid | | Medium | | | | | hardened |
| | | | Content | | Content | | Content | | Content | | Content | | | | epoxy- |
| | Color | | Ratio | | Ratio | | Ratio | | Ratio | | Ratio | Vis- | Boiling | Vapor | based |
| | of | | [wt. | | [wt. | | [wt. | | [wt. | | [wt. | cosity | Point | Pressure | adhesive |
| | Ink | | pts.] | | pts.] | | pts.] | | pts.] | | pts.] | [mP · s] | [° C.] | [mmHg] | [%] |
| Comp. | R | PR254 | 5.1 | PY150 | 1.9 | a | 2.0 | b | 4.8 | C | 86.2 | 7.9 | 171.0 | 0.6 | 31.5 |
| Ex. 1 | G | PG36 | 7.5 | PY150 | 2.8 | a | 2.2 | b | 4.9 | C | 82.6 | 7.8 | 171.0 | 0.6 | 31.5 |
| | B | PB15:6 | 4.8 | — | — | a | 1.9 | b | 4.9 | C | 88.4 | 7.7 | 171.0 | 0.6 | 31.5 |
| Comp. | R | PR254 | 5.2 | PY150 | 2.0 | a | 2.2 | b | 4.6 | G | 86.0 | 7.4 | 243.0 | 0.03 | 33.6 |
| Ex. 2 | G | PG36 | 7.5 | PY150 | 2.9 | a | 2.1 | b | 5.0 | G | 82.5 | 7.5 | 243.0 | 0.03 | 33.6 |
| | B | PB15:6 | 4.8 | — | — | a | 1.8 | b | 4.5 | G | 88.9 | 7.2 | 243.0 | 0.03 | 33.6 |
| Comp. | R | PR254 | 5.3 | PY150 | 2.0 | a | 2.1 | b | 4.8 | C/G | 17.2/68.6 | 7.5 | 228.4 | 0.32 | 32.98 |
| Ex. 3 | G | PG36 | 7.5 | PY150 | 2.9 | a | 2.2 | b | 5.2 | C/G | 16.4/55.8 | 7.4 | 228.4 | 0.32 | 32.98 |
| | B | PB15:6 | 4.8 | — | — | a | 1.8 | b | 4.5 | C/G | 17.8/71.1 | 7.2 | 228.4 | 0.32 | 32.98 |
| Comp. | R | PR254 | 5.1 | PY150 | 2.0 | a | 2.0 | b | 4.7 | C/I | 17.2/68.8 | 7.5 | 206.0 | 0.37 | 48.58 |
| Ex. 4 | G | PG36 | 7.2 | PY150 | 2.8 | a | 2.1 | b | 4.9 | C/I | 16.5/66.2 | 7.6 | 206.0 | 0.37 | 48.58 |
| | B | PB15:6 | 4.8 | — | — | a | 1.8 | b | 4.6 | C/I | 17.8/71.1 | 7.3 | 206.0 | 0.37 | 48.58 |
| Comp. | R | PR254 | 5.0 | PY150 | 2.1 | a | 2.1 | b | 4.8 | G/K | 43.0/43.0 | 7.3 | 229.5 | 0.04 | 42.7 |
| Ex. 5 | G | PG36 | 7.3 | PY150 | 2.8 | a | 2.2 | b | 4.9 | G/K | 41.4/41.4 | 7.4 | 229.5 | 0.04 | 42.7 |
| | B | PB15:6 | 4.8 | — | — | a | 1.9 | b | 5.3 | G/K | 44.0/44.0 | 7.1 | 229.5 | 0.04 | 42.7 |
| Comp. | R | PR254 | 5.3 | PY150 | 1.9 | a | 2.9 | b | 5.4 | I | 84.5 | 7.8 | 215.0 | 0.097 | 53.10 |
| Ex. 6 | G | PG36 | 7.2 | PY150 | 2.0 | a | 2.8 | b | 5.0 | I | 83.0 | 8.0 | 215.0 | 0.097 | 53.10 |
| | B | PB15:6 | 4.4 | — | — | a | 1.8 | b | 4.9 | I | 88.9 | 7.7 | 215.0 | 0.097 | 53.10 |
| Comp. | R | PR254 | 5.1 | PY150 | 1.9 | a | 2.9 | b | 4.8 | J | 85.3 | 8.0 | 275.3 | 0.01 | 43.52 |
| Ex. 7 | G | PG36 | 7.2 | PY150 | 2.0 | a | 1.9 | b | 5.1 | J | 83.8 | 8.2 | 275.3 | 0.01 | 43.52 |
| | B | PB15:6 | 4.5 | — | — | a | 2.4 | b | 5.8 | J | 87.3 | 7.8 | 275.3 | 0.01 | 43.52 |
| Comp. | R | PR254 | 5.0 | PY150 | 2.0 | a | 2.7 | b | 5.0 | K | 85.3 | 8.4 | 216.0 | 0.04 | 51.80 |
| Ex. 8 | G | PG36 | 7.0 | PY150 | 3.1 | a | 1.5 | b | 5.1 | K | 83.3 | 8.6 | 216.0 | 0.04 | 51.80 |
| | B | PB15:6 | 5.0 | — | — | a | 1.9 | b | 5.0 | K | 88.1 | 8.2 | 216.0 | 0.04 | 51.80 |

[2] Manufacturing of Color Filter

Color filters were fabricated by using the inks (ink set) for a color filter which had been prepared in the above-described examples and comparative examples.

A substrate (G5 size: 1100×1300 mm) which was made of soda glass and on which a silica (SiO₂) film was provided on both sides in order to prevent the elution of sodium ion was prepared. A cleaning treatment of the substrate was performed.

A radiation sensitive material which contains carbon black and was for forming a partition wall was provided onto one side of the cleaned substrate and an application film was formed. Subsequently a pre-bake treatment was performed at a heat temperature of 110° C. and for a heating period of 120 seconds. A post exposure bake (PEB) process was then carried out by irradiating the substrate through a photo-mask. A developing process using an alkaline developer was subsequently performed followed by a post-bake process and the partition wall was formed. The PEB was carried out at a heating temperature of 110° C., a heating duration of 120 seconds and a radiation irradiation intensity of 150 mJ/cm². The developing process was performed by for example a vibratory immersing method. A developing time was 60 seconds. The post-bake process was performed at a heat temperature of 150° and for a heating period of 5 minutes. The thickness of the fabricated partition wall was 2.1 μm.

The ink for a color filter was discharged into the cell where surrounded by the partition walls by using the droplet discharge device shown in FIGS. 3-6. Three color inks for a color filter were used and the discharge was performed such that each color of the color filter inks was not mixed each other. As for the droplet discharge head, the one having a nozzle plate which was adhered with the epoxy-based adhesive (AE-40 manufactured by Ajinomoto-Fine-Techno Co., Inc) was used.

The inks were heated by a hot plate at 100° C. for 10 minutes. Another heating process was further performed by an oven for a hour and the color parts colored with three colors were fabricated. In this way, the color filter shown in FIG. 1 was obtained. In the above-described way, 1000 color filters were manufactured respectively with each of the color filter inks of the above-described examples and comparative examples.

[Evaluation]

Evaluation of the manufactured color filters was performed in the following way.

[3.1] Unevenness in Color and Color Density, and Light Leak

Among the color filters manufactured by using the color filter inks (ink set) of the examples and comparative examples, the 1000th manufactured color filter was adopted to form the liquid display device shown in FIG. 7 and the liquid display device was assembled in the same way described above.

Sight evaluation of such liquid crystal displays was conducted to check if there is any unevenness in color and color density among parts. The liquid crystal display was placed in a dark room and monochromatic displays in red, green, blue and white of the liquid crystal display were observed by eye. The results of the evaluation were rated on the following five grades A-E: A: No unevenness in color and color density and light leak were recognized, B: Unevenness in color and color density and light leak were hardly recognized, C: Little unevenness in color and color density and light leak were found, D: Unevenness in color and color density and light leak were clearly found, and E: Significant unevenness in color and color density and light leak were found.

[3.2] Characteristic Difference Among Individual Manufactured Pieces

Among the color filters manufactured by using the color filter inks (ink set) of the examples and comparative examples, the 990-999th manufactured color filters were sampled and the liquid crystal display equipped with the respective sampled color filter was placed in a dark room and monochromatic displays in red, green, blue and white was performed. Color measurements of the displays were conducted by using a spectrophotometer (MCPD3000 manufactured by Otsuka Electronics Co., Ltd.). A maximum color difference among the 990-999th manufactured color filters (a color difference ΔE in L*a*b* color specification system) was calculated from the measurement results with respect to each example and comparative example. The calculated color difference was assessed and rated on the following five grades A-E: A: The color difference (ΔE) was smaller than 2, B: The color difference (ΔE) was not smaller than 2 and not exceeding 3, C: The color difference (ΔE) was not smaller than 3 and not exceeding 4, D: The color difference (ΔE) was not smaller than 4 and not exceeding 5, and E: The color difference (ΔE) was 4 and larger. The measurements and the observation of the color filters for the assessment were conducted under the identical conditions. The assessment results were given in Table 4.

TABLE 4

| | UNEVENNESS IN COLOR AND COLOR | | | | CHARACTERISTIC DIFFERENCE AMONG | | | |
|---|---|---|---|---|---|---|---|---|
| | DENSITY, AND LIGHT LEAK | | | | INDIVIDUAL MANUFACTURED PIECES | | | |
| | Red | Green | Blue | White | Red | Green | Blue | White |
| | display | display | display | display | display | display | display | display |
| Ex. 1 | A | A | A | A | A | A | A | A |
| Ex. 2 | A | A | A | A | A | A | A | A |
| Ex. 3 | A | A | A | A | A | A | A | A |
| Ex. 4 | A | A | A | A | A | A | A | A |
| Ex. 5 | A | B | A | A | A | B | A | B |
| Ex. 6 | A | A | A | A | A | A | A | A |
| Ex. 7 | A | A | A | A | A | A | A | A |
| Ex. 8 | A | A | A | A | A | B | A | A |
| Ex. 9 | A | A | A | B | A | B | A | B |
| Ex. 10 | A | B | A | A | A | B | A | A |
| Ex. 11 | A | B | A | A | A | B | A | A |
| Ex. 12 | B | B | A | B | B | B | A | B |
| Ex. 13 | B | B | A | B | A | B | A | B |
| Comp. | B | C | B | D | B | C | B | D |
| Ex. 1 | | | | | | | | |
| Comp. | B | C | A | C | B | C | A | C |
| Ex. 2 | | | | | | | | |
| Comp. | B | C | B | C | B | C | B | C |
| Ex. 3 | | | | | | | | |
| Comp. | C | C | B | C | C | C | B | C |
| Ex. 4 | | | | | | | | |
| Comp. | C | D | B | C | C | D | B | C |
| Ex. 5 | | | | | | | | |
| Comp. | C | D | C | C | C | D | D | C |
| Ex. 6 | | | | | | | | |
| Comp. | D | E | C | D | D | E | D | D |
| Ex. 7 | | | | | | | | |
| Comp. | D | E | C | E | D | E | D | E |
| Ex. 8 | | | | | | | | |

It can be seen from Table 4 that the occurrence of the unevenness in color and color density, and light leak was relatively less and the characteristic difference among individual manufactured pieces was relatively small whereas sufficient results could not be obtained for the comparative examples.

Moreover, a commercially-available liquid crystal TV was taken apart to a liquid crystal display part. The above-described manufactured display according to the embodiment was replaced by this liquid crystal display part and the same evaluations were conducted. The results were the same as those shown above.

What is claimed is:

1. Ink for a color filter used for manufacturing a color filter by an ink-jet method, the ink comprising:
a colorant; and
a liquid medium in which the colorant is at least one of dissolved and dispersed, the liquid medium including a compound that has at least one of an alkoxyl group and an acetyl group whose carbon number is 4 or more at an end of a molecular chain,
wherein the liquid medium has an adhesive swelling characteristic causing a hardened epoxy-based adhesive to have a swelling ratio of 30% or less after the hardened epoxy-based adhesive is left sealed in the liquid medium for 10 days under atmospheric pressure and at 40° C.

2. The ink for a color filter according to claim 1, the liquid medium including a compound having an acetyl group at both ends of a molecular chain.

3. The ink for a color filter according to claim 1, the liquid medium including a compound having an alkoxyl group whose carbon number is 4 or more at both ends of a molecular chain.

4. The ink for a color filter according to claim 1, the liquid medium including a compound having an ether oxygen atom that is coupled to a secondary carbon atom in a molecule.

5. The ink for a color filter according to claim 1, the epoxy-based adhesive containing an epoxy-based resin and an aliphatic polyamine.

6. The ink for a color filter according to claim 1, wherein a boiling point of the liquid medium at atmospheric pressure is in a range of 180 to 300° C.

7. The ink for a color filter according to claim 1, wherein a vapor pressure of the liquid medium at 25° C. is 0.1 mmHg or less.

8. A color filter manufactured by using the ink for a color filter according to claim 1.

9. An image display device comprising the color filter according to claim 8.

10. The image display device according to claim 9, wherein the image display device is a liquid crystal panel.

11. An electronic apparatus comprising the image display device according to claim 10.

12. A liquid droplet discharging apparatus comprising:
a tank;
a color filter ink stored in the tank; and
at least one liquid droplet discharging head in ink receiving communication with the tank and adapted to discharge the color filter ink to a desired location, the liquid droplet discharging head including:
a plurality of partition walls;
a nozzle plate bonded with a hardened epoxy adhesive to at least one of the partition walls;
wherein the color filter ink includes:
a colorant; and
a liquid medium in which the colorant is at least one of dissolved and dispersed, the liquid medium including a compound that has at least one of an alkoxyl group and an acetyl group whose carbon number is 4 or more at an end of a molecular chain,
wherein the liquid medium has an adhesive swelling characteristic causing the hardened epoxy-based adhesive to have a swelling ratio of 30% or less after the hardened epoxy-based adhesive is left sealed in the liquid medium for 10 days under atmospheric pressure and at 40° C.

13. The ink for a color filter according to claim 12, the liquid medium including a compound having an acetyl group at both ends of a molecular chain.

14. The ink for a color filter according to claim 12, the liquid medium including a compound having an alkoxyl group whose carbon number is 4 or more at both ends of a molecular chain.

15. The ink for a color filter according to claim 12, the liquid medium including a compound having an ether oxygen atom that is coupled to a secondary carbon atom in a molecule.

16. The ink for a color filter according to claim 12, the epoxy-based adhesive containing an epoxy-based resin and an aliphatic polyamine.

17. The ink for a color filter according to claim 12, wherein a boiling point of the liquid medium at atmospheric pressure is in a range of 180 to 300° C.

18. The ink for a color filter according to claim 12, wherein a vapor pressure of the liquid medium at 25° C. is 0.1 mmHg or less.
